(19) United States
(12) Patent Application Publication
(10) Pub. No.: US 2025/0036078 A1
(43) Pub. Date: Jan. 30, 2025

(54) SWITCH DEVICE AND TIMEPIECE

(71) Applicant: CASIO COMPUTER CO., LTD., Tokyo (JP)

(72) Inventor: Yoshiki NAKATSUKA, Tokyo (JP)

(73) Assignee: CASIO COMPUTER CO., LTD., Tokyo (JP)

(21) Appl. No.: 18/772,672

(22) Filed: Jul. 15, 2024

(30) Foreign Application Priority Data
Jul. 25, 2023 (JP) 2023-120673

(51) Int. Cl. G04B 3/04

(52) U.S. Cl. CPC G04B 3/043

(57) ABSTRACT

A switch device including a case provided with a through hole, a cylindrical member whose at least one portion is inserted into the through hole of the case, an operation member arranged extending from inside of the cylindrical member to outside of the cylindrical member, and a locking mechanism which locks the operation member to the cylindrical member, in which the locking mechanism includes a locking member which is locked to the cylindrical member by a rotation operation of the operation member, and a rotation transmission member which is a separate member from the locking member and rotates the locking member in accordance with the rotation operation of the operation member.

### CROSS-REFERENCE TO RELATED APPLICATION

This application is based upon and claims the benefit of priority from the prior Japanese Patent Application No. 2023-120673, filed Jul. 25, 2023, the entire contents of which are incorporated herein by reference.

### BACKGROUND

### 1. Technical Field

The present invention relates to a switch device that is used for electronic devices such as wristwatches, and a timepiece equipped with the switch device.

### 2. Description of the Related Art

Japanese Utility-Model Application Laid-Open (Kokai) Publication No. 52-52979 discloses the structure of a winder section of a wristwatch in which a fixing pipe is attached to a through hole in a wristwatch case, and an operation member is attached to the fixing pipe in a manner to be rotatable and slidable in an axial direction.

### SUMMARY

An embodiment of the present invention is a switch device comprising: a case provided with a through hole; a cylindrical member whose at least one portion is inserted into the through hole of the case; an operation member arranged extending from inside of the cylindrical member to outside of the cylindrical member; and a locking mechanism which locks the operation member to the cylindrical member, wherein the locking mechanism includes a locking member which is locked to the cylindrical member by a rotation operation of the operation member, and a rotation transmission member which is a separate member from the locking member and rotates the locking member in accordance with the rotation operation of the operation member.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged front view of an embodiment in which the present invention has been applied in a wristwatch;

FIG. 2 is an enlarged cross-sectional view showing a main portion of the wristwatch taken along the A-A arrow view in FIG. 1;

FIG. 3 is an enlarged cross-sectional view showing the main portion of the wristwatch, in which the locking of an operation member by a locking mechanism in a switch device shown in FIG. 2 has been released;

FIG. 4 is an exploded perspective view of the switch device of FIG. 2 when viewed from the outer side of the wristwatch case;

FIG. 5 is an exploded perspective view of the switch device of FIG. 4 when viewed from the inner side of the wristwatch case; and

FIG. 6 is an enlarged cross-sectional view of the main portion when the locked operation member in the switch device of FIG. 2 is subjected to an external impact.

### DETAILED DESCRIPTION OF THE PREFERRED EMBODIMENT

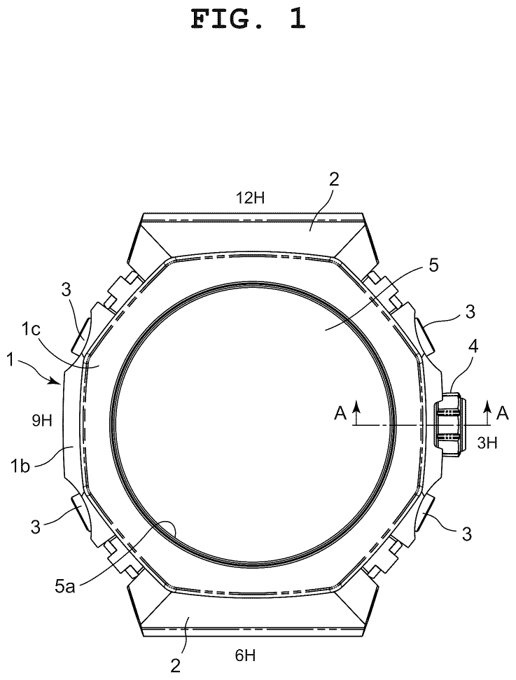

An embodiment where the present invention has been applied in a wristwatch will hereinafter be descried with reference to FIG. 1 to FIG. 6.

This wristwatch has a wristwatch case 1, as shown in FIG. 1. On the twelve o'clock side and six o'clock side of the wristwatch case 1, band attachment sections 2 where a watch band (not shown in the drawings) is attached are provided.

Here, Japanese Utility-Model Application Laid-Open (Kokai) Publication No. 52-52979 discloses the structure of a winder section of a wristwatch having a locking mechanism in which, when subjected to an external impact, an operation member is locked in a fixing pipe so that the operation member is not pressed into a wristwatch case and a timepiece module in the wristwatch case is not damaged.

The locking mechanism of the winder section of this wristwatch includes a male screw section which is formed on the outer circumferential surface of the fixing f pipe protruding outside the wristwatch case, and a female screw section which is formed in the inner surface of an operation head section on an outer end of the operation member and screwed onto the male screw section of the fixing pipe.

As a result, the locking mechanism is structured such that, when the operation head section is rotated with the operation member being pressed toward the inside of the wristwatch case and the operation head section being pressed against the fixing pipe, and the female screw section of the operation head section is screwed onto the male screw section of the fixing pipe, the operation member is locked in the fixing pipe.

However, the switch device of this wristwatch has a problem in that, when the operation head section is subjected to an external impact with the operation member being locked in the fixing pipe by the locking mechanism, the male screw section of the fixing pipe and the female screw section of the operation head section engaged with each other are damaged by the impact.

An object of the present invention is to improve and solve this problem so that a locking mechanism is prevented from being damaged by impacts.

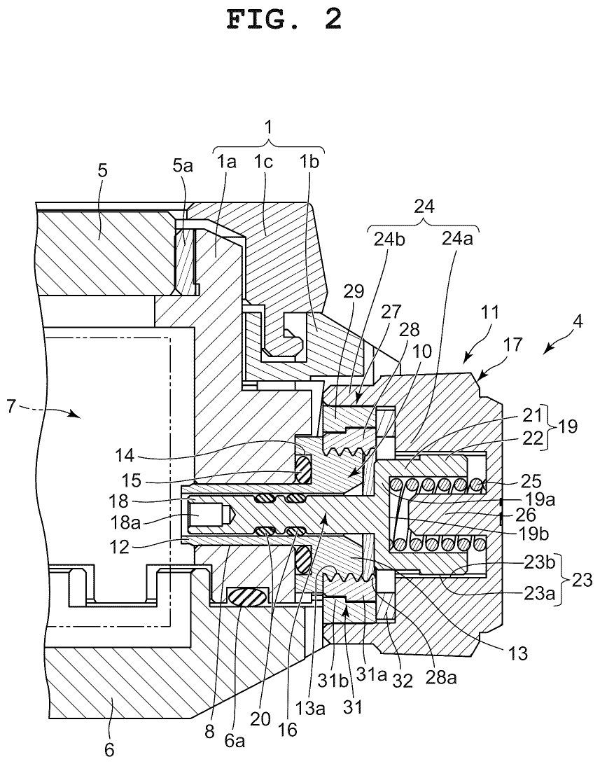

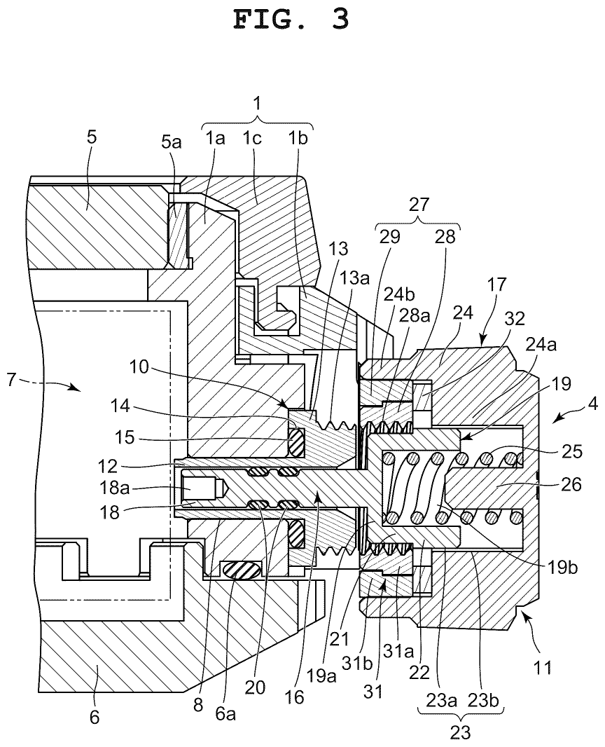

In the present embodiment, on the two o'clock side, four o'clock side, eight o'clock side, and ten o'clock side of the wristwatch case 1, push-button switches 3 are provided, respectively, as shown in FIG. 1. Also, on the three o'clock side of the wristwatch case 1, a switch device 4 is provided. Moreover, to the upper opening of the wristwatch case 1, a watch glass 5 is attached via a glass packing 5a, as shown in FIG. 2 and FIG. 3. Furthermore, to the lower part of this wristwatch case 1, a back cover 6 is attached by via a waterproof packing 6a.

Inside this wristwatch case 1, a timepiece module 7 is provided, as shown in FIG. 2 and FIG. 3. Although not shown in the drawings, the timepiece module 7 includes various types of components required for timepiece functions, such as a timepiece movement which moves pointers to indicate the time, a flat-type display device which electro-optically displays information such as a time of day, a date, and a day of the week, and a circuit section which drives and controls these components.

This wristwatch case 1 includes a case main body 1a, a first exterior member 1b which is arranged on the outer circumferential surface of the case main body 1a, and a second exterior member 1c which is arranged on the outer circumferential surface of the upper part of the case main body 1a and positioned over the first exterior member 1b, as shown in FIG. 2 and FIG. 3. Here, the case main body 1a is made of metal or a highly rigid synthetic resin, and the first exterior member 1b is made of an elastic synthetic resin such as urethane resin. The second exterior member 1c is made of metal or synthetic resin.

The switch device 4 on the three o'clock side of the wristwatch case 1 is a switch for performing time correction and function setting or selection such as mode switching, as shown in FIG. 1 to FIG. 3. This switch device 4 includes a cylindrical member 10 which is attached to a through hole 8 formed in the case main body 1a of the wristwatch case 1, an operation member 11 which is attached to the cylindrical member 10 in a manner to be slidable and rotatable, and a locking mechanism 27 which locks the operation member 11 to the cylindrical member 10.

The cylindrical member 10 is made of a highly rigid metal such as stainless steel, and has a substantially pipe shape, as shown in FIG. 2 and FIG. 3. This cylindrical member 10 includes a small-diameter cylindrical section 12 which is inserted into the through hole 8 in the case main body 1a of the wristwatch case 1, and a large-diameter cylindrical section 13 which is arranged protruding from the case main body 1a. The small-diameter cylindrical section 12 is formed such that its outer diameter is substantially equal to the inner diameter of the through hole 8 of the case main body 1a, and its inner diameter is slightly shorter than the inner diameter of the through hole 8. That is, this small-diameter cylindrical section 12 has a thin pipe shape.

Also, this small-diameter cylindrical section 12 is formed such that its axial length is slightly longer than the axial length of the through hole 8, as shown in FIG. 2 and FIG. 3. That is, this small-diameter cylindrical section 12 is structured such that, when the large-diameter cylindrical section 13 comes in contact with and is arranged on the outer surface of the case main body 1a of the wristwatch case 1, an inner end portion of the small-diameter cylindrical section 12 protrudes inside the case main body 1a. The cylindrical member 10 is structured such that the outer circumferential surface of the inner end portion of the small-diameter cylindrical section 12 protruding inside the wristwatch case 1 and a rim portion of the through hole 8 on the inner surface side of the case main body 1a are entirely welded to each other by laser welding or the like.

The large-diameter cylindrical section 13 is formed such that its outer diameter is longer than the inner diameter of the through hole 8 of the case main body 1a of the wristwatch case 1, and shorter than the vertical length (height) of the wristwatch case 1, as shown in FIG. 2 and FIG. 3. More specifically, the large-diameter cylindrical section 13 is formed such that its outer diameter is about three times longer than the inner diameter of the through hole 8 and about half the vertical length of the wristwatch case 1. Also, the large-diameter cylindrical section 13 is formed such that its inner diameter is equal to the inner diameter of the small-diameter cylindrical section 12.

That is, the large-diameter cylindrical section 13 has a pipe shape whose length (thickness) between the inner diameter and the outer diameter is sufficiently longer (thicker) than the length (thickness) between the inner diameter and outer diameter of the small-diameter cylindrical section 12, as shown in FIG. 2 and FIG. 3. Also, the large-diameter cylindrical section 13 is formed such that its axial length is substantially equal to the axial length of the through hole 8 in the case main body 1a of the wristwatch case 1.

Moreover, the large-diameter cylindrical section 13 is formed such that the outer diameter of its outer part which protrudes outside the case main body 1a of the wristwatch case 1 is one size shorter than the outer diameter of its inner part which is fitted into the case main body 1a of the wristwatch case 1, as shown in FIG. 2 and FIG. 3. Furthermore, the large-diameter cylindrical section 13 is formed such that the axial length of its inner part whose outer diameter is one size longer and the axial length of its outer part whose outer diameter is one size shorter are substantially equal to each other. On the outer circumferential surface of this outer part whose outer diameter is one size shorter, a male screw section 13a of the locking mechanism 27 which is described later is formed.

Also, in the inner end surface of the large-diameter cylindrical section 13 of the cylindrical member 10 corresponding to the outer surface of the case main body 1a, a waterproofing groove 14 which is recessed (becomes deeper) in an axial direction of the large-diameter cylindrical section 13 is annularly formed along the outer circumference of the small-diameter cylindrical section 12, as shown in FIG. 2 and FIG. 3. This waterproof groove 14 has a quadrangular cross-sectional shape, in which a waterproof packing 15 which is a waterproof member is provided.

The waterproof packing 15 is made of a synthetic rubber such as Nitrile Butadiene Rubber (NBR) or an elastic and hygroscopic material such as elastomer, and has a ring shape, as shown in FIG. 2 and FIG. 3. This waterproof packing 15 is pressed into the waterproofing groove 14 while being elastically deformed. As a result, this waterproof packing 15 is structured to achieve waterproofing between the inner end surface of the large-diameter cylindrical section 13 and the outer surface of the wristwatch case 1.

On the other hand, the operation member 11 which is attached to the cylindrical member 10 includes an operation shaft section 16 which is slidably and rotatably arranged in the cylindrical member 10 and protrudes outside the cylindrical member 10, and an operation head section 17 which is attached to an outer end portion of the operation shaft section 16 protruding from the cylindrical member 10 in a manner to be slidable in the axial directions and covers the outer end portion of the operation shaft section 16 and the large-diameter cylindrical section 13 of the cylindrical member 10, as shown in FIG. 2 to FIG. 5. The operation shaft section 16 is made of a metal such as stainless steel or titanium alloy or a hard synthetic resin.

The operation shaft section 16 includes a shaft body section 18 which is inserted into the cylindrical member 10, and a shaft operation section 19 which is provided on the outer end of the shaft body section 18 and protrudes outside the cylindrical member 10, as shown in FIG. 2 to FIG. 5. The shaft body section 18 is formed such that its outer diameter is substantially equal to the inner diameter of the cylindrical member 10, and its axial length is substantially equal to that of the cylindrical member 10.

As a result, the shaft body section 18 is rotatably and slidably arranged in the cylindrical member 10 when the outer end of the shaft body section 18 is positioned at the outer end of the cylindrical member 10 and the inner end of the shaft body section 18 is positioned on the inner end side of the cylindrical member 10, as shown in FIG. 2 to FIG. 5. Also, in outer circumferential portions of the shaft body section 18, a plurality of waterproof rings 20 is provided to be spaced apart from each other, which is structured to achieve waterproofing between the outer circumferential surface of the shaft body section 18 and the inner circumferential surface of the cylindrical member 10.

The shaft operation section 19 is integrally provided with the outer end of the shaft body section 18 positioned at the outer end of the cylindrical member 10, and structured to slide and rotate the shaft body section 18, as shown in FIG. 2 to FIG. 5. More specifically, the shaft operation section 19 is formed in a substantially cylindrical shape, and has a bottom section 19a formed on the outer end of the shaft body section 18. In the shaft operation section 19, a hollow recess section 19b having a circular shape is formed in an axial direction of the operation member 11. This hollow recess section 19b is formed such that its inner diameter is equal to or slightly longer than the outer diameter of the small-diameter cylindrical section 12 of the cylindrical member 10.

Also, this shaft operation section 19 includes an inner cylindrical section 21 whose outer circumferential part has a small diameter and an outer cylindrical section 22 whose outer circumferential part has a large diameter, as shown in FIG. 2 and FIG. 3. The small-diameter inner cylindrical section 21 is formed such that its outer diameter is slightly shorter than the outer diameter of the male screw section 13a formed on the outer circumference surface of the large-diameter cylindrical section 13 of the cylindrical member 10, that is, slightly shorter than the inner diameter of a female screw section 28a in the locking mechanism 27 which is described later.

Also, the small-diameter inner cylindrical section 21 is structured such that its inner end portion, that is, the bottom section 19a of the shaft operation section 19 comes close to the outer end of the large-diameter cylindrical section 13 of the cylindrical member 10, that is, the outer end surface of the male screw section 13a while being separable therefrom, as shown in FIG. 2 and FIG. 3. As a result, the small-diameter inner cylindrical section 21 is structured such that its inner end portion, that is, the bottom section 19a of the shaft operation section 19 does not come in contact with the outer end surface of the female screw section 28a of a locking member 28. When the locking of the large-diameter cylindrical section 13 by the operation head section 17 is released, the female screw section 28a of the locking member 28 is moved to and arranged around the outer circumference of the small-diameter inner cylindrical section 21.

The large-diameter outer cylindrical section 22 is formed such that its outer diameter is substantially equal to the outer diameter of the inner part of the large-diameter cylindrical section 13 which is one size longer as described above, shorter than the outer diameter of the locking member 28, and longer than the inner diameter of the female screw section 28a of the locking member 28, as shown in FIG. 2 to FIG. 5. This large-diameter outer cylindrical section 22 is structured such that the outer end surface of the locking member 28 comes in contact with the inner end thereof. Note that, because of being provided with a first operation flat-surface section 23a of a first idling prevention section 23 described later, the outer diameter of the large-diameter outer cylindrical section 22 in FIG. 2 and FIG. 3 has been drawn short for descriptive purposes.

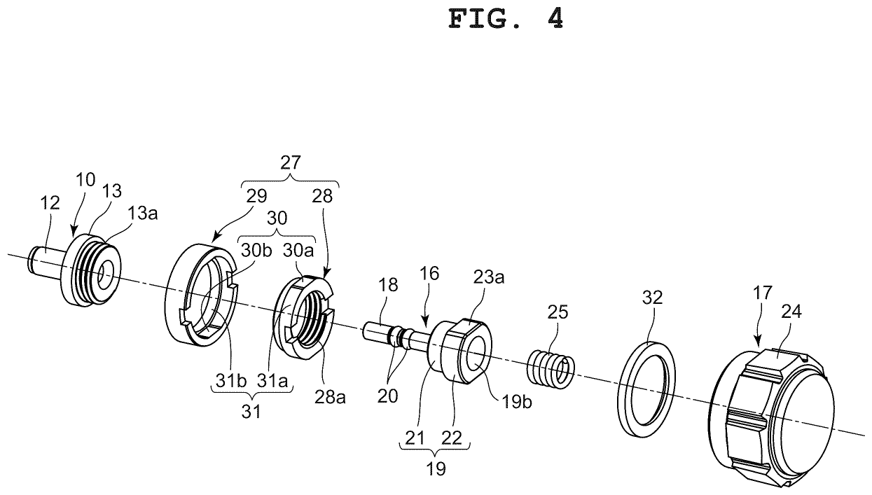

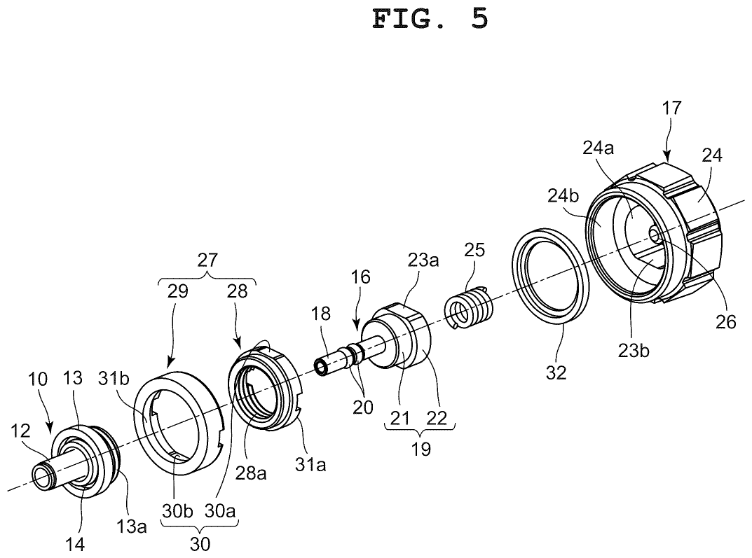

That is, in practice, the outer diameter of the large-diameter outer cylindrical section 22 is sufficiently longer than the outer diameter of the small-diameter inner cylindrical section 21, as shown in FIG. 4 and FIG. 5. As a result, the large-diameter outer cylindrical section 22 is structured such that, when the locking of the operation head section 17 by the locking mechanism 27 is released, the female screw section 28a of the locking member 28 is moved to be positioned around the outer circumference of the small-diameter inner cylindrical section 21, the outer end of the locking member 28 comes in contact with the inner end of the large-diameter outer cylindrical section 22 while being in a separable state, as shown in FIG. 3.

Also, the large-diameter outer cylindrical section 22 is arranged in the operation head section 17 in a manner to be slidable in an axial direction, and rotated together with the operation head section 17, as shown in FIG. 2 and FIG. 3. More specifically, the outer circumferential surface of the large-diameter outer cylindrical section 22 and the inner circumferential surface of the operation head section 17 are provided with the first idling prevention section 23 for rotating the large-diameter outer cylindrical section 22 by the operation head section 17.

On the other hand, the operation head section 17 includes a cover section 24 into which the shaft operation section 19 of the operation shaft section 16 is inserted and which covers the large-diameter cylindrical section 13 of the cylindrical member 10, and a spring member 25 which is an energizing member for forcing the cover section 24 in a direction to be pressed outside the wristwatch case 1, as shown in FIG. 2 to FIG. 5. The cover section 24 is made of a metal such as titanium alloy, and has a substantially cylindrical shape whose outer end is closed.

This cover section 24 has a substantially circular shape whose outer diameter is sufficiently longer than that of the large-diameter cylindrical section 13 of the cylindrical member 10, and about two-thirds of the vertical length of the wristwatch case 1, as shown in FIG. 2 to FIG. 5. Also, this cover section 24 includes a small-diameter cover section 24a into which the shaft operation section 19 of the operation shaft section 16 is inserted, and a large-diameter cover section 24b into which the large-diameter cylindrical section 13 of the cylindrical member 10 and the locking mechanism 27 are inserted so as to be covered.

On the other hand, the first idling prevention section 23 includes a first operation flat-surface section 23a which is provided on the outer circumferential surface of the outer cylindrical section 22 of the shaft operation section 19, and a first cover flat-surface section 23b which is provided on the inner circumferential surface of the small-diameter cover section 24a of the cover section 24 of the operation head section 17, and pressed corresponding to the first operation flat-surface section 23a of the outer cylindrical section 22, as shown in FIG. 2, FIG. 3, and FIG. 5.

That is, the first idling prevention section 23 is structured such that the large-diameter outer cylindrical section 22 and the operation head section 17 are relatively slidable in an axial direction and integrally rotatable without being idle, with the first operation flat-surface section 23a of the outer cylindrical section 22 and the first cover flat-surface section 23b of the small-diameter cover section 24a corresponding to and being in contact with each other, as shown in FIG. 2, FIG. 3, and FIG. 5.

In the cover section 24, a spring guide section 26 is formed, as shown in FIG. 2, FIG. 3, and FIG. 5. This spring guide section 26, which is to guide the spring member 25, has a round bar shape, and formed on a substantially central portion of the inner end surface of the cover section 24 in an axial direction of the cover section 24. Also, this spring guide section 26 is formed such that its outer diameter is substantially equal to that of the shaft body section 18.

Moreover, this spring guide section 26 is formed such that its axial length is shorter than that of the hollow recess section 19b of the shaft operation section 19, as shown in FIG. 2, FIG. 3, and FIG. 5. As a result, when the shaft operation section 19 is inserted into the cover section 24, this spring guide section 26 is arranged in the hollow recess section 19b of the shaft operation section 19 without coming in contact with the hollow recess section 19b.

The spring member 25 is a coil spring structured to be arranged in the hollow recess section 19b of the shaft operation section 19 while being arranged around the outer circumference of the spring guide section 26, as shown in FIG. 2 to FIG. 5. More specifically, this spring member 25 is formed such that its inner diameter is slightly longer than the outer diameter of the spring guide section 26 and its outer diameter is shorter than the inner diameter of the hollow recess section 19b of the shaft operation section 19. One end of this spring member 25 comes in contact with the inner surface of the bottom section 19a in the hollow recess section 19b of the shaft operation section 19, and the other end comes in contact with the inner end surface of the cover section 24 on the outer side.

That is, the spring member 25, which forces the cover section 24 in a direction to be pressed toward the outside of the wristwatch case 1, is compressed in an axial direction when the cover section 24 is locked by the locking mechanism 27, and released in an axial direction when the locking of the cover section 24 by the locking mechanism 27 is released, as shown in FIG. 2 to FIG. 5.

The operation shaft section 16 is structured such that a winding core (not shown in the drawings) is inserted into a connection hole 18a formed in an inner end portion of the shaft body section 18, as shown in FIG. 2 and FIG. 3. As a result, the winding core is structured such that, when the operation shaft section 16 is slid and rotated by an operation performed on the operation head section 17, this winding core is slid and rotated together with the operation shaft section 16.

Although not shown in the drawings, the winding core is structured to be idle relative to the timepiece module 7 when pressed into the timepiece module 7. Also, the winding core is structured such that, when pulled one step outward with locking by the locking mechanism 27 being released, this winding core is connected to the timepiece module 7 and rotated in response to a rotation operation performed on the operation head section 17, whereby time correction and function setting or selection such as mode switching can be performed.

That is, the operation shaft section 16 is structured such that, when the winding core (not shown in the drawings) is pressed into the timepiece module 7 by the shaft body section 18 being pressed into the inner side of the wristwatch case 1, released from being connected to the timepiece module 7, and rotated by the shaft operation section 19 being rotated, this rotation is not transmitted to the timepiece module 7, whereby time correction and function setting or selection such as mode switching cannot be performed, as shown in FIG. 2.

Also, the operation shaft section 16 is structured such that, when the shaft body section 18 is pulled toward the outside of the wristwatch case 1 in the state shown in FIG. 3, and the winding core (not shown in the drawings) is slid in the direction to be pulled out of the timepiece module 7, connected to the timepiece module 7, and rotated by the shaft operation section 19 being rotated, this rotation is transmitted to the timepiece module 7, whereby time correction and function setting or selection such as mode switching can be performed.

On the other hand, the locking mechanism 27 includes the locking member 28 which is locked to the large-diameter cylindrical section 13 of the cylindrical member 10 by a rotation operation, and a rotation transmission member 29 to which the locking member 28 is attached in a manner to be slidable in an axial direction and which rotates the locking member 28 in response to a rotation operation performed on the operation member 11, as shown in FIG. 2 to FIG. 5. The locking member 28, which is arranged on the inner side of the rotation transmission member 29, has a ring shape and is made of a metal such as stainless steel.

This locking member 28 has the female screw section 28a formed in its inner circumferential surface, as shown in FIG. 2 to FIG. 5. Into this female screw section 28a, the male screw section 13a formed on the outer circumferential surface of the large-diameter cylindrical section 13 of the cylindrical member 10 is screwed. The locking member 28 is formed such that its axial length is slightly longer than the axial length of the male screw section 13a of the large-diameter cylindrical section 13 of the cylindrical member 10. As a result of the structure of this locking member 28, when the female screw section 28a is screwed onto the male screw section 13a, the outer end surface of the locking member 28 projects further than the outer end surface of the large-diameter cylindrical section 13 toward the outer side of the wristwatch case 1.

Also, this locking member 28 is formed such that its outer diameter is longer than the inner diameter of the small-diameter cover section 24a of the operation head section 17 and shorter than the inner diameter of the large-diameter cover section 24b, as shown in FIG. 2 to FIG. 5. As a result of the structure of this locking member 28, when the locking of the large-diameter cylindrical section 13 of the cylindrical member 10 is released, the cover section 24 of the operation head section 17 is pressed toward the outside of the wristwatch case 1 by the spring force of the spring member 25.

Accordingly, in the case of this locking member 28, when the cover section 24 of the operation head section 17 is pressed toward the outside of the wristwatch case 1 by the spring force of the spring member 25, the female screw section 28a of the locking member 28 is moved and positioned corresponding to the outer circumference of the small-diameter inner cylindrical section 21 of the shaft operation section 19, and the outer end of the locking member 28 comes in contact with the inner end surface of the large-diameter outer cylindrical section 22 in this state, as shown in FIG. 2 to FIG. 5.

The rotation transmission member 29 is made of a metal such as stainless steel and has a ring shape, as shown in FIG. 2 to FIG. 5. This rotation transmission member 29 is formed such that its inner diameter is substantially equal to the outer diameter of the locking member 28, and its axial length is substantially equal to that of the locking member 28. Also, this rotation transmission member 29 is formed such that its outer diameter is equal to or slightly longer than the inner diameter of the large-diameter cover section 24b of the cover section 24 of the operation head section 17.

Accordingly, the rotation transmission member 29 is fixed in the large-diameter cover section 24b of the cover section 24 of the operation head section 17 by press fitting with the locking member 28 being arranged inside this rotation transmission member 29, as shown in FIG. 2 to FIG. 5. As a result, this rotation transmission member 29 is not slid with respect to the cover section 24, and is structured to integrally rotate with the operation head section 17, transmit the rotation to the locking member 28, and thereby rotate the locking member 28.

Also, the locking member 28 and the rotation transmission member 29 are structured to be relatively slid and integrally rotated by a second idling prevention section 30, as shown in FIG. 2 to FIG. 5. More specifically, the second idling prevention section 30 includes a second locking flat-surface section 30a formed on the outer circumferential surface of the locking member 28 and a second transmission flat-surface section 30b formed on the inner side of the rotation transmission member 29 so as to correspond to the second locking flat-surface section 30a.

As a result, the second idling prevention section 30 is structured such that, when the second locking flat-surface section 30a of the locking member 28 and the second transmission flat-surface section 30b of the rotation transmission member 29 are corresponding to each other, the locking member 28 and the rotation transmission member 29 are relatively slidable in an axial direction and are integrally rotated without being idle, as shown in FIG. 4 and FIG. 5.

Also, the locking mechanism 27 includes a stopper section 31 which prevents the locking member 28 from slipping out of the rotation transmission member 29 toward the wristwatch case 1 side, as shown in FIG. 2 to FIG. 6. This stopper section 31 includes a large-diameter contact section 31a formed on the outer circumferential surface of the locking member 28, and a small-diameter contact section 31b formed on the inner circumferential surface of the rotation transmission member 29. More specifically, the large-diameter contact section 31a is formed on the outer side part of the outer circumferential surface of the locking member 28, and the small-diameter contact section 31b is formed on the inner side part of the inner circumferential surface of the rotation transmission member 29.

The large-diameter contact section 31a of the locking member 28 is formed such that its outer diameter is equal to the inner diameter of the rotation transmission member 29, and longer than the inner diameter of the small-diameter contact section 31b of the rotation transmission member 29, as shown in FIG. 2 to FIG. 6. Also, the small-diameter contact section 31b of the rotation transmission member 29 is formed such that its inner diameter is equal to the outer diameter of the locking member 28, and shorter than the outer diameter of the large-diameter contact section 31a of the locking member 28.

Note that, because the second locking flat-surface section 30a of the second idling prevention section 30 is corresponding to the outer diameter of the large-diameter contact section 31a, the outer diameter of the large-diameter contact section 31a in FIG. 2 and FIG. 3 has been drawn short for descriptive purposes. That is, in practice, the large-diameter contact section 31a is formed such that its outer diameter is sufficiently longer than the inner diameter of the small-diameter contact section 31b, as shown in FIG. 4 and FIG. 5. As a result, in the case of this stopper section 31, the inner end surface of the large-diameter contact section 31a of the locking member 28 comes in contact with the outer end surface of the small-diameter contact section 31b of the rotation transmission member 29 in a manner to be separable.

Also, this stopper section 31 is structured such that, when the rotation transmission member 29 is moved toward the outside of the wristwatch case 1 together with the cover section 24 of the operation head section 17, the inner end surface of the large-diameter contact section 31a of the locking member 28 comes in contact with the outer end surface of the small-diameter contact section 31b of the rotation transmission member 29, whereby the locking member 28 is moved together with the rotation transmission member 29, and prevented from slipping out of the rotation transmission member 29 toward the wristwatch case 1 side, as shown in FIG. 3.

On the other hand, in the large-diameter cover section 24b of the cover section 24 of the operation head section 17, a buffer member 32 is provided, as shown in FIG. 2 to FIG. 6. This buffer member 32 is made of a buffer material such as alpha gel or silicone rubber and has a ring shape. More specifically, this buffer member 32 is arranged between the outer end surface of the locking mechanism 27 where the locking member 28 has been arranged in the rotation transmission member 29 and the outer end surface of the large-diameter cover section 24b of the cover section 24 corresponding thereto in an axial direction, that is, the stepped surface formed by the large-diameter cover section 24b and the small-diameter cover section 24a.

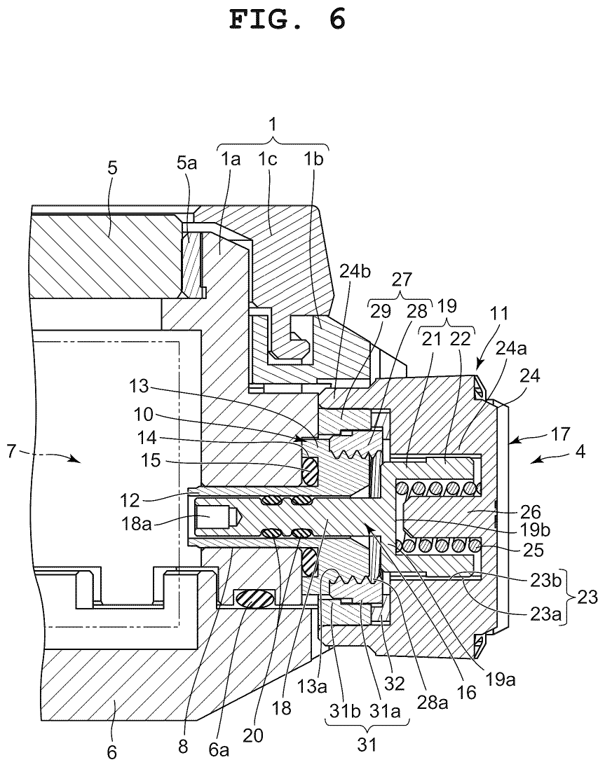

As a result, when the cover section 24 of the operation head section 17 is subjected to an external impact with the operation head section 17 being locked by the locking mechanism 27, the buffer member 32 is held between the large-diameter cover section 24b of the cover section 24 and the locking member 28 of the locking mechanism 27 and compressed in an axial direction so as to buffer the impact, as shown in FIG. 2 and FIG. 6.

Also, this buffer member 32 is structured such that, when the buffer member 32 is compressed in an axial direction by an external impact with the female screw section 28a of the locking member 28 of the locking mechanism 27 and the male screw section 13a of the large-diameter cylindrical section 13 being engaged with each other, the rotation transmission member 29 is moved toward the wristwatch case 1 side together with the cover section 24, whereby the impact is not applied to the female screw section 28a and the male screw section 13a, as shown in FIG. 2 and FIG. 6.

This switch device 4 is structured such that, in an operation for locking the operation head section 17 to the cylindrical member 10 by the locking mechanism 27, when the cover section 24 of the operation head section 17 is rotated in a predetermined direction with the operation head section 17 being pressed against the spring force of the spring member 25 toward the large-diameter cylindrical section 13 of the cylindrical member 10, the rotation transmission member 29 is rotated along with the rotation of the cover section 24, whereby the locking member 28 is rotated and the female screw section 28a of the locking member 28 is screwed onto the male screw section 13a of the large-diameter cylindrical section 13 of the cylindrical member 10, as shown in FIG. 2.

That is, in the case of this switch device 4, when the female screw section 28a of the locking member 28 is to be screwed onto the male screw section 13a of the large-diameter cylindrical section 13 of the cylindrical member 10, the second locking flat-surface section 30a of the locking member 28 of the second idling prevention section 30 and the second transmission flat-surface section 30b of the rotation transmission member 29 are positioned corresponding to each other so as to come in contact with each other, as shown in FIG. 2. Then, in this switch device 4, the locking member 28 is rotated together with the rotation transmission member 29 by the rotation operation of the operation head section 17, and the female screw section 28a of the locking member 28 is screwed onto the male screw section 13a of the large-diameter cylindrical section 13 of the cylindrical member 10.

Also, this switch device 4 is structured such that, in an operation for releasing the locking of the operation head section 17 with respect to the large-diameter cylindrical section 13 of the cylindrical member 10, when the cover section 24 of the operation head section 17 is rotated in the reverse direction, and the female screw section 28a of the locking member 28 and the male screw section 13a of the large-diameter cylindrical section 13 of the cylindrical member 10 are released from being engaged, the cover section 24 of the operation head section 17 is pressed toward the outside of the wristwatch case 1 together with the locking mechanism 27 by the spring force of the spring member 25, as shown in FIG. 3.

Moreover, this switch device 4 is structured such that, when the locking of the operation head section 17 with respect to the large-diameter cylindrical section 13 of the cylindrical member 10 is released, and the cover section 24 and the locking mechanism 27 are pressed by the spring force of the spring member 25 toward the outside of the wristwatch case 1, the locking member 28 and the rotation transmission member 29 are moved toward the outside of the wristwatch case 1 together with the cover section 24 by the stopper section 31 of the locking mechanism 27, as shown in FIG. 3.

That is, this switch device 4 is structured such that, when the locking of the operation head section 17 with respect to the cylindrical member 10 is released, and the cover section 24 of the operation head section 17 and the locking mechanism 27 are pressed by the spring force of the spring member 25 toward the outside of the wristwatch case 1, the inner end surface of the large-diameter contact section 31a of the locking member 28 in the stopper section 31 comes in contact with the outer end surface of the small-diameter contact section 31b of the rotation transmission member 29, as shown in FIG. 3.

Also, in the case of this switch device 4, the operation shaft section 16 does not slide in the axial direction when the locking of the operation head section 17 with respect to the cylindrical member 10 is released and the cover section 24 of the operation head section 17 and the locking mechanism 27 are pressed by the spring force of the spring member 25 toward the outside of the wristwatch case 1, as shown in FIG. 3. Moreover, this switch device 4 is structured such that the female screw section 28a of the locking member 28 and the rotation transmission member 29 are moved to the outer circumference of the small-diameter inner cylindrical section 21 of the shaft operation section 19 of the operation shaft section 16 by the spring force of the spring member 25, and the outer end of the locking member 28 is pressed against the inner end of the large-diameter outer cylindrical section 22.

Moreover, this switch device 4 is structured such that, when the locking of the operation head section 17 with respect to the cylindrical member 10 is released, and the operation head section 17 is pulled one step further toward the outside of the wristwatch case 1 with the cover section 24 of the operation head section 17 and the locking mechanism 27 being pressed toward the outside of the wristwatch case 1 by the spring force of the spring member 25, the locking member 28 pulls the operation shaft section 16 toward the outside of the wristwatch case 1 since the outer end surface of the locking member 28 is in contact with the inner end surface of the large-diameter outer cylindrical section 22 of the shaft operation section 19, as shown in FIG. 3.

Furthermore, this switch device 4 is structured such that, when the cover section 24 of the operation head section 17 pulls the locking mechanism 27 and the operation shaft section 16 toward the outside of the wristwatch case 1 in the state shown in FIG. 3, the winding core (not shown in the drawings) connected to the connection hole 18a of the shaft body section 18 is slid in the direction to be pulled out of the clock module 7, and connected to the clock module 7.

Still further, this switch device 4 is structured such that, when the winding core (not shown in the drawings) is slid in the direction to be pulled out of the clock module 7 in the state shown in FIG. 3, and the operation head section 17 is rotated with the winding core being connected to the clock module 7, this rotation is transmitted to the winding core via the operation shaft section 16, whereby time correction and function setting or selection such as mode switching can be performed.

Next, a procedure for assembling this wristwatch is described.

In the assembly, first, the watch glass 5 is attached to the upper opening of the wristwatch case 1 together with the glass packing 5a. In this state, the push-button switches 3 are attached to the two o'clock side, four o'clock side, eight o'clock side, and ten o'clock side of the wristwatch case 1, respectively, and the cylindrical member 10 of the switch device 4 is attached to the through hole 8 on the three o'clock side of the wristwatch case 1.

Here, before this attachment, the waterproof packing 15 is arranged in the waterproof groove 14 formed in the inner surface of the large-diameter cylindrical section 13 of the cylindrical member 10. In this state, the small-diameter cylindrical section 12 of the cylindrical member 10 is inserted into the through hole 8 in the case main body 1a of the wristwatch case 1 from the outer side, and the inner surface of the large-diameter cylindrical section 13 of the cylindrical member 10 is pressed against the outer surface of the case main body 1a. Accordingly, the waterproof packing 15 is elastically deformed and pressed into the waterproof groove 14. As a result, waterproofing between the outer circumferential surface of the cylindrical member 10 and the inner circumferential surface of the through hole 8 is reliably achieved.

Here, the inner end portion of the small-diameter cylindrical section 12 of the cylindrical member 10 protrudes inside the case main body 1a of the wristwatch case 1. In this state, the outer circumferential part of the inner end portion of the small-diameter cylindrical section 12 protruding inside the case main body 1a and the rim portion of the inner end of the through hole 8 of the case main body 1a are entirely welded to each other by laser welding or the like. As a result, the cylindrical member 10 is firmly attached to the through hole 8 of the case main body 1a of the wristwatch case 1 so as not to slip out toward the outside of the wristwatch case 1.

Then, the clock module 7 is mounted in the wristwatch case 1, and the operation member 11 is attached to the cylindrical member 10 of the switch device 4. Here, before this attachment, the plurality of waterproof rings 20 is attached to the outer circumferential surface of the shaft body section 18 of the operation shaft section 16. In this state, the operation head section 17 is attached to the shaft operation section 19 of the operation shaft section 16. Here, before this attachment, the spring member 25 is arranged around the outer circumference of the spring guide section 26 formed in the cover section 24 of the operation head section 17.

Then, the spring guide section 26 of the cover section 24 is inserted into the hollow recess section 19b of the shaft operation section 19 of the operation shaft section 16 together with the spring member 25. Here, the first operation flat-surface section 23a of the first idling prevention section 23 formed on the outer circumferential surface of the outer cylindrical section 22 of the shaft operation section 19 and the first covering flat-surface section 23b formed on the inner circumferential surface of the small-diameter cover section 24a are positioned corresponding to each other and the shaft operation section 19 is inserted into the small-diameter cover section 24a of the cover section 24. As a result, the shaft operation section 19 is arranged in a manner to be slidable in an axial direction in the cover section 24 and integrally rotated with the cover section 24.

In this state, the locking mechanism 27 is mounted in the large-diameter cover section 24b of the cover section 24. Here, before this mounting operation, the locking mechanism 27 is assembled. In the assembly, the ring-shaped locking member 28 is inserted into and arranged in the ring-shaped rotation transmission member 29. Here, the second locking flat-surface section 30a of the second idling prevention section 30 formed on the outer circumferential surface of the locking member 28 and the second transmission flat-surface section 30b formed surface of the rotation on the inner circumferential transmission member 29 are positioned corresponding to each other.

In this state, when inserted into the ring-shaped rotation transmission member 29, the ring-shaped locking member 28 enters a state where this locking member 28 is slidable with respect to the rotation transmission member 29 and rotatable together with the rotation transmission member 29. In addition, here, the outer end portion of the small-diameter contact section 31b of the rotation transmission member 29 which constitutes the stopper section 31 comes in contact with the inner end portion of the large-diameter contact section 31a of the locking member 28 which also constitutes the stopper section 31. As a result, the locking mechanism 27 is assembled such that the locking member 28 does not slip out toward the wristwatch case 1 side.

When the locking mechanism 27 assembled as described above is to be mounted in the cover section 24 of the operation head section 17, the ring-shaped buffer member 32 is arranged in the large-diameter cover section 24b of the cover section 24 in advance. In this state, the rotation transmission member 29 of the locking mechanism 27 is fitted into the large-diameter cover section 24b of the cover section 24 by press fitting, and fixed in the large-diameter cover section 24b.

This state is shown in FIG. 3, and the cover section 24 of the operation head section 17 is pressed by the spring force of the spring member 25 toward the outside of the wristwatch case 1. Accordingly, the female screw section 28a of the locking member 28 of the locking mechanism 27 is arranged on the outer circumferential surface of the small-diameter inner cylindrical section 21 of the shaft operation section 19 of the operation member 11, and the outer end of the female screw section 28a comes in contact with the inner end of the large-diameter outer cylindrical section 22. As a result, the operation head section 17 of the operation member 11 is attached to the shaft operation section 19 of the operation shaft section 16 without slipping off the shaft operation section 19.

As described above, in this structure, the rotation transmission member 29 is press-fitted into the cover section 24, so that the cover section 24 and the rotation transmission member 29 are unified and not separated from each other. Also, since the outer circumferential surface of the locking member 28 and the inner circumferential surface of the rotation transmission member 29 have step surfaces, the step surface of the outer circumferential surface of the locking member 28 is arranged corresponding to the step surface of the inner circumferential surface of the rotation transmission member 29, whereby positional restriction is achieved.

Then, the shaft body section 18 of the operation shaft section 16 is inserted into the cylindrical member 10 from the outside of the wristwatch case 1. Here, before this insertion, the outer end portion of the winding core (not shown in the drawings) is fitted into and connected to the connection hole 18a formed in the inner end portion of the shaft body section 18 of the operation shaft section 16. In this state, the winding core is inserted into the cylindrical member 10 together with the operation shaft section 16, and inserted into and attached to the clock module 7.

Here, when the shaft body section 18 of the operation shaft section 16 is inserted into the small-diameter cylindrical section 12 of the cylindrical member 10, waterproofing between the small-diameter cylindrical section 12 and the shaft body section 18 is achieved by the plurality of waterproof rings 20. In addition, the winding core is slidably and rotatably attached to the inside of the clock module 7 with the locking mechanism 27 of the operation head section 17 being arranged close to the male screw section 13a of the large-diameter cylindrical section 13 of the cylindrical member 10.

In this state, the winding core is slid along with the slide movement of the operation shaft section 16 inserted into the cylindrical member 10, and rotated along with the rotation of the operation shaft section 16. As a result, the assembly of the switch device 4 is completed. Then, the back lid 6 is attached to the lower part of the wristwatch case 1 together with the waterproof packing 6a, whereby the assembly of the wristwatch is completed.

Next, the mechanism of the switch device 4 of this wristwatch is described.

When this wristwatch is to be used by being worn on an arm, first, the operation head section 17 of the switch device 4 is locked to the large-diameter cylindrical section 13 of the cylindrical member 10 by the locking mechanism 27. Here, the cover section 24 of the operation head section 17 is moved toward the large-diameter cylindrical section 13 against the spring force of the spring member 25, and the inner end of the female screw section 28a of the locking member 28 is pressed against the outer end of the male screw section 13a of the large-diameter cylindrical section 13.

In this state, when the cover section 24 is rotated, the rotation transmission member 29 of the locking mechanism 27 is rotated together with the cover section 24, and this rotation of the rotation transmission member 29 is transmitted to the locking member 28 by the first idling prevention section 23, whereby the locking member 28 is rotated. By this rotation of the locking member 28, the female screw section 28a of the locking member 28 is screwed onto the male screw section 13a of the large-diameter cylindrical section 13 and tightened.

Here, the operation shaft section 16 is not pressed into the cylindrical member 10, and the bottom section 19a which is the inner end part of the shaft operation section 19 of the operation shaft section 16 receives the spring force of the spring member 25, whereby the spring member 25 is compressed. Accordingly, the state where the bottom section 19a of the shaft operation section 19 is close to the outer end of the large-diameter cylindrical section 13, that is, the outer end of the male screw section 13a is maintained. As a result, the operation head section 17 of the switch device 4 is locked to the large-diameter cylindrical section 13 of the cylindrical member 10.

Here, since the bottom section 19a which is the inner end part of the shaft operation section 19 of the operation shaft section 16 is close to the outer end of the large-diameter cylindrical section 13 with the spring member 25 being compressed, the winding core (not shown in the drawings) fitted into and connected to the connection hole 18a formed in the inner end portion of the shaft body section 18 of the operation shaft section 16 is not pressed into the clock module 7. Also, in this state, since the operation head section 17 has been locked to the large-diameter cylindrical section 13 of the cylindrical member 10, the operation member 11 is not rotated, and therefore the winding core is not rotated inside the clock module 7.

In this state, when the cover section 24 of the operation head section 17 is subjected to an external impact, the outer end portion of the large-diameter cover section 24b of the cover section 24, that is, the stepped portion formed by the large-diameter cover section 24b and the small-diameter cover section 24a is pressed against the buffer member 32 by the impact. Here, the buffer member 32 is held and compressed between the stepped portion that is the outer end portion of the large-diameter cover section 24b and the outer end of the locking member 28 of the locking mechanism 27, whereby the impact is buffered by the buffer member 32.

Also, here, the rotation transmission member 29 of the locking mechanism 27 is axially slid with respect to the locking member 28 together with the cover section 24 subjected to the impact. Therefore, even when the female screw section 28a of the locking member 28 and the male screw section 13a of the large-diameter cylindrical section 13 of the cylindrical member 10 have engaged with each other, the impact is not applied to the female screw sections 28a and the male screw section 13a.

As a result, the female screw section 28a and the male screw section 13a are prevented from being damaged by the impact. Also, the impact received by the cover section 24 is also buffered by the spring member 25, so that the operation shaft section 16 is not damaged. Accordingly, the winding core (not shown in the drawings) is not pressed into the clock module 7 by the impact, whereby the clock module 7 is not damaged.

On the other hand, in the case of time correction and function setting or selection such as mode switching, first, the locking of the operation head section 17 with respect to the large-diameter cylindrical section 13 of the cylindrical member 10 by the locking mechanism 27 is released. Here, the cover section 24 of the operation head section 17 is rotated in the reverse direction so as to rotate the rotation transmission member 29 of the locking mechanism 27, whereby the rotation transmission member 29 rotates the locking member 28 in the same direction by the second idling prevention section 30.

Then, when the locking member 28 is rotated, the female screw section 28a of the locking member 28 is released from being engaged with the male screw section 13a of the large-diameter cylindrical section 13. Then, the operation head section 17 is pressed by the spring force of the spring member 25 toward the outside of the wristwatch case 1, and the female screw section 28a of the locking member 28 is moved to the outer circumference of the small-diameter inner cylindrical section 21 of the of the shaft operation section 19. Along with this movement, the outer end of the locking member 28, that is, the outer end of the female screw section 28a comes in contact with the inner end of the large-diameter outer cylindrical section 22 of the shaft operation section 19 of the operation shaft section 16.

Here, since the operation shaft section 16 is not slid in the axial direction, the winding core (not shown in the drawings) connected to the connection hole 18a of the shaft body section 18 is not slid either. Accordingly, the winding core maintains to be arranged in an idle state in the clock module 7. That is, even when the operation shaft section 16 is rotated by the cover section 24 of the operation head section 17 being rotated, and the winding core is rotated along with this rotation of the operation shaft section 16, the rotation of the winding core is not transmitted to the clock module 7, whereby time correction and function setting or selection such as mode switching are not performed.

In this state, the operation head section 17 is pulled toward the outside of the wristwatch case 1. Here, since the outer end of the locking member 28 in the cover section 24 is in contact with the inner end of the large-diameter outer cylindrical section 22 of the shaft operation section 19 of the operation shaft section 16, the rotation transmission member 29 of the locking mechanism 27 and the locking member 28 pull the shaft operation section 19 and the spring member 25 by the pulling operation on the operation head section 17. Then, the shaft body section 18 of the operation shaft section 16 is slid in the axial direction and pulled one step further, whereby the winding core (not shown in the drawings) connected to this shaft body section 18 is pulled outward.

When the winding core is pulled outward as described above, the rotation of the winding core can be transmitted to the clock module 7. In this state, when the cover section 24 of the operation head section 17 is rotated, this rotation is transmitted to the operation shaft section 16 by the first idling prevention section 23, and the shaft body section 18 of the operation shaft section 16 is rotated. Then, the winding core is rotated along with the rotation of the operation shaft section 16, and this rotation is transmitted to the clock module 7. As a result, time correction and function setting or selection such as mode switching can be performed.

As described above, the switch device 4 of this wristwatch includes the wristwatch case 1 provided with the through hole 8, the cylindrical member 10 whose at least one portion is inserted into the through hole 8 of the wristwatch case 1, the operation member 11 arranged extending from the inside of the cylindrical member 10 to the outside of the cylindrical member 10, the locking mechanism 27 which locks the operation member 11 to the cylindrical member 10. The locking mechanism 27 includes the locking member 28 which is locked to the cylindrical member 10 by the rotational movement of the operation member 11, and the rotation transmission member 29 which is a separate member from the locking member 28 and rotates the locking member 28 in accordance with the rotation operation of the operation member 11. As a result of this structure, the locking mechanism 27 is prevented from being damaged by external impacts.

That is, in the case of the switch device 4 of this wristwatch, since the locking mechanism 27 includes the locking member 28 which is locked to the cylindrical member 10 by the rotational movement of the operation member 11, and the rotation transmission member 29 which is a separate member from the locking member 28 and rotates the locking member 28 in accordance with the rotation operation of the operation member 11, the rotation transmission member 29 can be axially slid with respect to the locking member 28 when the operation member 11 is subjected to an external impact with the locking member 28 being locked to the cylindrical member 10, whereby the impact is not applied to the locking member 28 and the cylindrical member 10, and the locking mechanism 27 is prevented from being damaged by the impact.

Also, in the switch device 4 of this wristwatch, the cylindrical member 10 includes the small-diameter cylindrical section 12 which is inserted into the through hole 8 of the wristwatch case 1, and the large-diameter cylindrical section 13 which protrudes outside the wristwatch case 1, and the locking member 28 is arranged on the inner circumferential surface side of the rotation transmission member 29 and locked to the large-diameter cylindrical section 13 of the cylindrical member 10. As a result of this structure, the large-diameter cylindrical section 13 protrudes outside the wristwatch case 1 and is unfailingly fixed to the through hole 8 of the wristwatch case 1, and the locking member 28 is unfailingly and favorably fixed to the large-diameter cylindrical section 13.

Moreover, in the switch device 4 of this wristwatch, the operation member 11 includes the operation shaft section 16 which is arranged in the cylindrical member 10, and the operation head section 17 which is attached to the outer part of the operation shaft section 16 in a manner to be slidable in an axial direction and covers the large-diameter cylindrical section 13 of the cylindrical member 10. As a result of this structure, when the operation head section 17 is subjected to an external impact while being locked to the large-diameter cylindrical section 13 by the locking mechanism 27, this operation head section 17 is slid with respect to the operation shaft section 16 along with the slide of the rotation transmission member 29 with respect to the locking member 28. Accordingly, even when the operation head section 17 is slid, the impact is not transmitted to the operation shaft section 16, whereby the clock module 7 in the wristwatch case 1 is prevented from being damaged.

Furthermore, the switch device 4 of this wristwatch includes the spring member 25 which is an energizing member that forces the operation head section 17 toward the outside. Accordingly, even when the operation head section 17 is subjected to an external impact with the operation head section 17 being locked to the large-diameter cylindrical section 13 by the locking mechanism 27, and slid with respect to the operation shaft section 16, the impact is buffered by the spring force of the spring member 25, and not transmitted to the operation shaft section 16, whereby the clock module 7 in the wristwatch case 1 is prevented from being damaged.

Still further, the switch device 4 of this wristwatch includes the first idling prevention section 23 by which the operation shaft section 16 is integrally rotated with the operation head section 17 in a manner to be slidable in an axial direction with respect to the operation head section 17. As a result of this structure, by the first idling prevention section 23, the operation head section 17 is slidable in an axial direction. In addition, the rotation of the operation head section 17 is unfailingly transmitted to the operation shaft section 16, whereby the operation shaft section 16 is favorably rotated.

That is, the first idling prevention section 23 includes the first operation flat-surface section 23a provided on the outer circumferential surface of the shaft operation section 19 of the operation shaft section 16, and the first covering flat-surface section 23b provided on the inner circumferential surface of the cover section 24 of the operation head section 17. By being positioned corresponding to each other, the first operation flat-surface section 23a and the first covering flat-surface section 23b come in contact with each other. As a result of this structure, the operation head section 17 can be slid in an axial direction with respect to the operation shaft section 16, and the rotation of the operation head section 17 can be reliably transmitted to the operation shaft section 16.

Also, in the switch device 4 of this wristwatch, the rotation transmission member 29 of the locking mechanism 27 is fixed in the operation head section 17 of the operation member 11 by press fitting. Accordingly, the rotation transmission member 29 and the operation head section 17 can be integrally rotated, and integrally moved in an axial direction. As a result of this structure, the rotation transmission member 29 can be rotated by the rotation operation of the operation head section 17. In addition, along with the movement of the operation head section 17 in an axial direction, the rotation transmission member 29 can be moved in the same direction.

Moreover, because of the structure where the rotation transmission member 29 of the locking mechanism 27 is fixed in the operation head section 17 by press fitting, the rotation transmission member 29 can be fitted and inserted into the inside of the operation head section 17 together with the locking member 28 with the shaft operation section 19 of the operation shaft section 16 being arranged in the operation head section 17. AS a result of this structure, the rotation transmission member 29 can be attached such that the operation shaft section 16 does not slip out of the operation head section 17, with the locking member 28 of the locking mechanism 27 being slidable with respect to the shaft operation section 19 of the operation shaft section 16.

Furthermore, in the switch device 4 of this wristwatch, the locking mechanism 27 includes the second idling prevention section 30 which integrally rotates the locking member 28 with the rotation transmission member 29 such that the locking member 28 is slidable with respect to the rotation transmission member 29. Accordingly, by the second idling prevention section 30, the rotation transmission member 29 can be slid in an axial direction with respect to the locking member 28, and the rotation of the rotation transmission member 29 can be unfailingly transmitted to the locking member 28.

More specifically, the second idling prevention section 30 includes the second locking flat-surface section 30a formed on the outer circumferential surface of the locking member 28 and the second transmission flat-surface section 30b formed on the inner circumferential surface of the rotation transmission member 29. By being positioned corresponding to each other, the second operation flat-surface section 30a and the second transmission flat-surface section 30b come in contact with each other. As a result of this structure, the rotation transmission member 29 can be slid in an axial direction with respect to the locking member 28, and the rotation of the rotation transmission member 29 can be unfailingly transmitted to the locking member 28. As such, since the second locking flat-surface section 30a of the locking member 28 and the second transmission flat-surface section 30b of the rotation transmission member 29 are in contact with each other, the idling of the rotation transmission member 29 with respect to the locking member 28 can be restricted.

Also, the switch device 4 of this wristwatch includes the stopper section 31 which prevents the locking member 28 of the locking mechanism 27 from slipping out of the rotation transmission member 29 toward the wristwatch case 1 side. Accordingly, when the locking of the operation member 11 with respect to the cylindrical member 10 is released, the locking member 28 can be moved together with the rotation transmission member 29 toward the outside of the wristwatch case 1 by the stopper section 31. As a result of this structure, switch operations can be favorably performed.

That is, in the case of the switch device 4 of this wristwatch, when the locking member 28 of the locking mechanism 27 is to be locked to the large-diameter cylindrical section 13 of the cylindrical member 10 by the rotation operation of the operation head section 17, the locking member 28 can be moved together with the rotation transmission member 29 toward the wristwatch case 1 side by the stopper section 31, whereby the locking member 28 can be unfailingly and favorably locked to the cylindrical member 10.

Also, in the switch device 4 of this wristwatch, the buffer member 32 is provided between the rotation transmission member 29 and locking member 28 of the locking mechanism 27 and the inner end surface of the operation head section 17 of the operation member 11 axially opposing the rotation transmission member 29 and the locking member 28. Accordingly, when the operation head section 17 is subjected to an external impact, this impact can be buffered by the buffer member 32.

That is, when buffering the impact, the buffer member 32 is compressed in response to the impact. Accordingly, the rotation transmission member 29 of the locking mechanism 27 can be slid with respect to the locking member 28 in accordance with the compression of the buffer member 32. By this structure as well, the impact is not applied to the male screw section 13a of the large-diameter cylindrical section 13 of the cylindrical member 10 and the female screw section 28a of the locking member 28, whereby the male screw section 13a and the female screw section 28a can be prevented from being damaged.

Also, in the switch device 4 of this wristwatch, the locking member 28 includes the female screw section 28a which is screwed onto the male screw section 13a provided on the outer circumferential surface of the large-diameter cylindrical section 13 of the cylindrical member 10. Accordingly, when the operation head section 17 of the operation member 11 is rotated and the locking member 28 is rotated, the female screw section 28a is screwed onto the male screw section 13a of the large-diameter cylindrical section 13 along with the rotation of the locking member 28, whereby the operation head section 17 can be reliably locked to the cylindrical member 10.

In the above-described embodiment, the locking mechanism 27 has a screw locking structure in which the operation head section 17 is locked to the large-diameter cylindrical section 13 by the male screw section 13a and the female screw section 28a engaging each other. However, the present invention is not limited thereto, and the locking mechanism 27 may have a simplified locking structure in which, for example, an engaging projection is provided on the locking member 28, and an engaging groove which engages with the engaging projection is formed in the large-diameter cylindrical section 13.

In that case, in the simplified locking mechanism, the operation head section 17 is pressed toward the wristwatch case 1 side, the engaging projection of the locking member 28 is inserted into the engaging groove through the opening of the engaging groove of the large-diameter cylindrical section 13, the operation head section 17 is rotated in this state by a predetermined angle (such as 90 degrees), and the engaging projection of the locking member 28 is rotated by a predetermined angle in the locking groove of the large-diameter cylindrical section 13 and separated from the opening, whereby the engaging projection of the locking member 28 engages with the engaging groove of the large-diameter cylindrical section 13.

Also, in the above-described embodiment, the first idling prevention section 23 includes the first operation flat-surface section 23a which is provided on the outer circumferential surface of the outer cylindrical section 22 of the shaft operation section 19 of the operation shaft section 16, and the first cover flat-surface section 23b which is provided on the inner circumferential surface of the small-diameter cover section 24a of the cover section 24 corresponding thereto. However, the present invention is not limited thereto. For example, the first idling prevention section 23 may have a structure in which the outer circumferential surface of the outer cylindrical section 22 and the inner circumferential surface of the small-diameter cover section 24a corresponding thereto are formed in a non-circular shape such as a polygonal shape including a quadrilateral shape and a pentagonal shape, or an elliptical shape.

Moreover, in the above-described embodiment, the second idling prevention section 30 includes the second locking flat-surface section 30a formed on the outer circumferential surface of the locking member 28 and the second transmission flat-surface section 30b formed on the inner circumferential surface of the rotation transmission member 29 corresponding thereto. However, the present invention is not limited thereto. For example, the second idling prevention section 30 may have a structure in which the outer circumferential surface of the locking member 28 and the inner circumferential surface of the rotation transmission member 29 corresponding thereto are formed in a non-circular shape such as a polygonal shape including a quadrilateral shape and a pentagonal shape, or an elliptical shape.

Furthermore, in the above-described embodiment, the switch device 4 has the structure where the winding core (not shown in the drawings) in the clock module 7 is pulled one step further. However, the present invention is not limited thereto. For example, the switch device 4 may have a structure in which the winding core (not shown in the drawings) in the clock module 7 can be pulled further in multiple steps such two or more steps.

Still further, in the above-described embodiment, the present invention has been applied in the switch device 4 on the three o'clock side. However, the present invention is not limited thereto, and may be applied in the push-button switch 3 on the two o'clock side, the four o'clock side, the eight o'clock side, or the ten o'clock side.

Yet still further, in the above-described embodiment, the present invention has been applied in a wristwatch. However, the scope of the present invention is not limited to the above-described embodiment. The specific configuration, structure, and positional relationship shown in the above-described embodiment may be appropriately changed within the scope of the present invention. Also, the present invention is not necessarily required to be applied in a wristwatch. For example, the present invention is applicable to various types of timepieces such as a travel watch, an alarm clock, a table clock, and a wall clock. In addition, the present invention is not necessarily required to be applied in timepieces, and can be applied in electronic devices such as portable information terminals.

While the present invention has been described with reference to the preferred embodiments, it is intended that the invention be not limited by any of the details of the description therein but includes all the embodiments which fall within the scope of the appended claims.

1. A switch device comprising:
a case provided with a through hole;
a cylindrical member whose at least one portion is inserted into the through hole of the case;
an operation member arranged extending from inside of the cylindrical member to outside of the cylindrical member; and
a locking mechanism which locks the operation member to the cylindrical member,
wherein the locking mechanism includes a locking member which is locked to the cylindrical member by a rotation operation of the operation member, and a rotation transmission member which is a separate member from the locking member and rotates the locking member in accordance with the rotation operation of the operation member.

2. The switch device according to claim 1, wherein the cylindrical member includes a small-diameter cylindrical portion which is inserted into the through hole of the case, and a large-diameter cylindrical portion which protrudes outside the case, and
wherein the locking member is arranged on an inner circumferential surface side of the rotation transmission member and locked to the large-diameter cylindrical portion of the cylindrical member.

3. The switch device according to claim 2, wherein the operation member includes an operation shaft portion which is arranged in the cylindrical member, and an operation head portion which is attached to an outer part of the operation shaft portion in a manner to be slidable in an axial direction and covers the large-diameter cylindrical portion of the cylindrical member.

4. The switch device according to claim 3, wherein the rotation transmission member is fixed in the operation head portion of the operation member by press fitting.

5. The switch device according to claim 1, wherein the locking mechanism includes an idling prevention portion which integrally rotates the locking member with the rotation transmission member such that the locking member is slidable with respect to the rotation transmission member.

6. The switch device according to claim 2, wherein the locking mechanism includes an idling prevention portion which integrally rotates the locking member with the rotation transmission member such that the locking member is slidable with respect to the rotation transmission member.

7. The switch device according to claim 3, wherein the locking mechanism includes an idling prevention portion which integrally rotates the locking member with the rotation transmission member such that the locking member is slidable with respect to the rotation transmission member.

8. The switch device according to claim 4, wherein the locking mechanism includes an idling prevention portion which integrally rotates the locking member with the rotation transmission member such that the locking member is slidable with respect to the rotation transmission member.

9. The switch device according to claim 1, wherein the locking mechanism includes a stopper portion which prevents the locking member from slipping out of the rotation transmission member toward the case side.

10. The switch device according to claim 2, wherein the locking mechanism includes a stopper portion which prevents the locking member from slipping out of the rotation transmission member toward the case side.

11. The switch device according to claim 3, wherein the locking mechanism includes a stopper portion which prevents the locking member from slipping out of the rotation transmission member toward the case side.

12. The switch device according to claim 4, wherein the locking mechanism includes a stopper portion which prevents the locking member from slipping out of the rotation transmission member toward the case side.

13. The switch device according to claim 3, wherein a buffer member is provided between the rotation transmission member and locking member of the locking mechanism and the operation head portion of the operation member axially opposing the rotation transmission member and the locking member.

14. The switch device according to claim 4, wherein a buffer member is provided between the rotation transmission member and locking member of the locking mechanism and the operation head portion of the operation member axially opposing the rotation transmission member and the locking member.

15. The switch device according to claim 7, wherein a buffer member is provided between the rotation transmission member and locking member of the locking mechanism and the operation head portion of the operation member axially opposing the rotation transmission member and the locking member.

16. The switch device according to claim 8, wherein a buffer member is provided between the rotation transmission member and locking member of the locking mechanism and the operation head portion of the operation member axially opposing the rotation transmission member and the locking member.

17. The switch device according to claim 2, wherein a male screw portion is formed on an outer circumferential surface of the large-diameter cylindrical portion of the cylindrical member.

18. The switch device according to claim 3, wherein a male screw portion is formed on an outer circumferential surface of the large-diameter cylindrical portion of the cylindrical member.

19. The switch device according to claim 17, wherein a female screw portion which is screwed onto the male screw portion of the cylindrical member is formed in the locking member.

20. A timepiece comprising the switch device according to claim 1.
